(19) United States
(12) Patent Application Publication
(10) Pub. No.: US 2026/0175167 A1
(43) Pub. Date: Jun. 25, 2026

(54) COMBINED SYSTEM CONTROLLER AND REAGENT DELIVERY SYSTEM

(71) Applicant: Applied Materials, Inc., Santa Clara, CA (US)

(72) Inventor: Ryan T. DOWNEY, San Jose, CA (US)

(21) Appl. No.: 19/000,214

(22) Filed: Dec. 23, 2024

(51) Int. Cl. B01D 53/32

(52) U.S. Cl. CPC B01D 53/32; B01D 2257/2066; B01D 2257/404; B01D 2257/708; B01D 2258/0216; B01D 2259/818

(57) ABSTRACT

The present disclosure provides an abatement device including a foreline plasma reactor, a reagent delivery system configured to provide one or more reagent gases to a foreline coupled upstream of the foreline plasma reactor, and a system controller incorporated within the reagent delivery system and configured to simultaneously control reagent delivery and abatement functions of multiple chambers of a substrate processing tool. The system controller dynamically adjusts a flow of reagent gases based on emission profiles of the multiple chambers. The system controller regulates reagent gas delivery to each of the multiple chambers while simultaneously managing abatement processes to neutralize or capture byproducts.

### BACKGROUND

### Field

Embodiments of the present invention generally relate to abatement systems in semiconductor manufacturing, and, more particularly, to combining a system controller and a reagent delivery system.

### Description of the Related Art

In semiconductor manufacturing, plasma-based processes such as etching and deposition generate hazardous byproducts, including hazardous gases and particulates. These byproducts pose environmental and safety risks, necessitating effective abatement systems. Plasma abatement technology addresses these challenges by using plasma, which is a high-energy, ionized gas, to break down harmful emissions into less hazardous compounds. Plasma abatement systems are beneficial for ensuring compliance with strict environmental regulations, reducing emissions, and improving the safety of semiconductor fabrication facilities. Their integration with substrate processing tools enables the neutralization of harmful gases before they are released into the environment, enhancing both process efficiency and sustainability.

### SUMMARY

In one example, an abatement device includes a foreline plasma reactor, a reagent delivery system configured to provide one or more reagent to a foreline coupled upstream of the foreline plasma reactor, and a system controller incorporated within the reagent delivery system and configured to simultaneously control reagent delivery and abatement functions of multiple chambers of a substrate processing tool.

In one example, a reagent delivery system a plurality of reagent distributors, each distributor configured to controllably split distribution of a reagent provided to the reagent delivery system among a plurality of reagent distributor outlet ports and a system controller configured to simultaneously flow from the plurality of reagent distributor outlet ports to multiple chambers of a substrate processing tool.

In one example, a method includes controlling, using a system controller, reagent gas delivery to a first foreline coupled to a first processing chamber a substrate processing tool and simultaneously controlling, using the system controller, reagent gas delivery to a second foreline coupled to a second processing chamber the substrate processing tool.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments of the present disclosure and are therefore not to be considered limiting of its scope, and the present disclosure may admit to other equally effective embodiments.

FIG. 1 is a schematic diagram of a processing system, according to one or more embodiments.

FIG. 2 is a schematic diagram of an abatement device enclosure of the processing system, according to one or more embodiments.

FIG. 3 is a flowchart illustrating using a system controller to manage abatement and reagent delivery functions, according to one or more embodiments.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Embodiments of the present invention generally relate to abatement systems in semiconductor manufacturing, and, more particularly, to combining a plasma abatement controller and a reagent delivery system.

Plasma abatement is a process used to neutralize or treat harmful gases and byproducts generated during semiconductor fabrication, especially in etching and deposition processes. During these processes, hazardous gases (like fluorinated compounds, volatile organic compounds, and nitrogen oxides) are often released. Plasma abatement systems break down these hazardous emissions using plasma, a high-energy ionized gas. The plasma reacts with these gases to convert them into safer byproducts, such as water, carbon dioxide, and other less harmful compounds, before they are released into the environment. A reagent gas is a chemical gas used in abatement processes that actively participates in a chemical reaction to achieve a desired result, such as reduction in the hazards of the process gases. In processes like chemical vapor deposition (CVD) or plasma etching, the reagent gas can be used to reduce the greenhouse gas potency of the process gases. Common process gases include fluorine-containing gases, and chlorine-based gases, each chosen for specific reactions depending on the material being processed.

The plasma abatement solution reduces emissions of high-global warming potential (GWP) gases, such as perfluorocarbons (PFCs), nitrogen trifluoride (NF₃), and sulfur hexafluoride (SF₆), which are commonly used in semiconductor manufacturing. The plasma abatement system uses plasma dissociation technology to treat smaller, concentrated volumes of gas before they are pumped out, minimizing both energy use and harmful emissions like nitrogen oxides (NOx). The benefits of using such plasma abatement system include, by treating gas volumes pre-pump and on-demand, the plasma abatement system consumes less energy compared to traditional post-pump abatement systems that operate continuously. The plasma dissociation process breaks down fluorinated gases into harmless byproducts with near-zero NOx emissions, aligning with strict environmental regulations. The plasma abatement system is effective in neutralizing gases like carbon tetrafluoride (CF₄) and octafluorocyclobutane (C₄F₈), helping to reduce greenhouse gas emissions in semiconductor processes.

Reagent gases are delivered via a reagent delivery system. The reagent delivery system delivers one or more reagents, such as abating reagents (which may be, for example, volatilizing or condensing abating reagents) into a foreline or treatment region according to instructions by a controller. The abating reagents may include, hydrogen containing gases such as e.g., water, ammonia (NH₃), hydrogen (H₂), etc., as well as, oxygen (O₂), and/or nitrogen. As such, the reagent delivery system is the equipment and infrastructure used to store, transport, and deliver reagent gases (or sometimes liquids) into the semiconductor process forelines with precise control over flow rates, pressure, and concentration.

In the current state of the art for semiconductor manufacturing, plasma abatement systems are constructed so that each chamber of a process tool operates independently with its own dedicated control and reagent delivery components. This configuration involves separate controllers and gas delivery systems for each chamber to manage the abatement of harmful emissions, such as those generated during etching or deposition processes. Each chamber's plasma abatement system is connected to a distinct set of reagent gas delivery lines, which supply the specific gases needed for neutralizing the byproducts of that chamber's processes. These reagents may include O₂, H₂, or other gases that can be used in a plasma abatement system to reduce the hazards of process chamber effluent.

This individualized approach allows for precise control over the abatement process within each chamber, accommodating the unique emissions profile generated by different substrate processing steps. For example, one chamber may be used for a fluorinated plasma etching process, while another may perform a CVD process, each involving different abatement strategies. The separate controllers and delivery systems ensure that each chamber operates with the optimal abatement conditions, maintaining high process efficiency and regulatory compliance. However, this setup also involves a complex infrastructure, as it involves dedicated pipelines, control valves, and flow meters for each reagent gas used in every chamber. This results in increased cost, space requirements, and system complexity, which present challenges in the current design.

To address such challenges, the example embodiments allow for the plasma abatement controller and reagent gas delivery functions of a substrate processing tool to be combined into a single integrated device, improving efficiency and reducing complexity. This unified system centralizes control over the abatement and gas delivery operations across multiple chambers within the process tool, facilitating streamlined management of reagent gas supply and plasma abatement for all chambers concurrently or simultaneously. Instead of having separate controllers and delivery components for each chamber, this architecture integrates these functions into one single device that handles the abatement needs of the entire tool, regardless of the specific processes running in each chamber.

Further, the integrated or unified system of the example embodiments enables shared connections for reagent gases, reducing the need for individual pipelines, control valves, and flow meters for each chamber. A centralized controller or single system controller dynamically adjusts the flow of reagent gases, such as O₂ or H₂, based on the real-time emission profiles of different chambers, ensuring that the correct reagents are delivered to neutralize harmful byproducts across all processes. The single system controller regulates reagent delivery to each chamber based on its specific requirements while simultaneously managing abatement processes to neutralize or capture byproducts. This setup allows for dynamic adjustments in real-time, reducing any delays between reagent injection and byproduct treatment. This approach further reduces redundancy, lowers infrastructure costs, and simplifies maintenance, as fewer components are needed. Moreover, by optimizing reagent gas usage across chambers and combining the control logic, the single system controller enhances energy efficiency and resource utilization. This consolidated abatement system ensures more efficient operation and scalability, particularly in advanced semiconductor fabs with multi-chamber process tools, improving both operational efficiency and environmental performance.

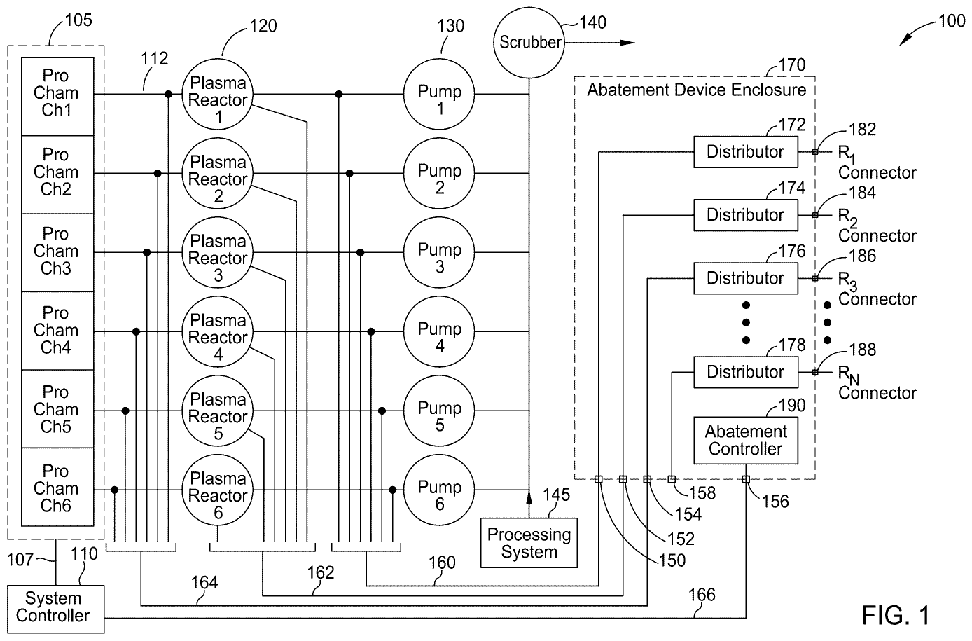

FIG. 1 is a schematic diagram of a processing system, according to one or more embodiments.

The processing system 100 includes multiple chambers 105 coupled, via connection 107, to a system controller 110 communicating with an abatement system 170. The abatement system 170 can be referred to as an abatement device or abatement device enclosure or abatement enclosure or simply enclosure.

The processing system 100 includes the multiple chambers 105 fluidly coupled with the abatement system 170 via the system controller 110. In one example, there are six chambers. In other examples, there can be more or less chambers. The multiple chambers 105 can be generally configured to perform at least one integrated circuit manufacturing process, such as a deposition process, a clean process, an etch process, a plasma treatment process, a pre-clean process, an ion implant process, or other integrated circuit manufacturing process. Processes performed in the multiple chambers 105 can be, e.g., plasma assisted. In one example, the process performed in a processing chamber can be a plasma etch process for etching a silicon-based material.

Pumps 130, such as vacuum pumps, can be disposed along the foreline 112 downstream from the multiple chambers 105 and the plasma reactors 120. The foreline 112 is a pathway that connects the multiple chambers 105 to the pumps 130. The foreline 112 helps manage vacuum levels inside the multiple chambers 105 and provides a conduit for gases and byproducts to be drawn out of the multiple chambers 105. The pumps 130 may be coupled to other processing systems 145, including a scrubber 140 used to neutralize, filter, or remove gases and byproducts generated during the plasma process before they are released to the environment.

The abatement system 170 includes multiple distributors connected to multiple inlets. In one example, a first inlet 182 is connected to a first distributor 172, a second inlet 184 is connected to a second distributor 174, a third inlet 186 is connected to a third distributor 176, and an Nth inlet 188 is connected to an Nth distributor 178. Multiple distributors with multiple inlets may be provided based on the application.

The first distributor 172 is connected to a first output 150, the second distributor 174 is connected to a second output 152, the third distributor 176 is connected to a third output 154, and the Nth distributor 178 is connected to an Nth output 158. Multiple distributors connected to multiple outlets may be provided based on the application. In one example, each outlet may include six channels, as there are six processing chambers. As such, the first output 150 may include six channels, the second output 152 may include six channels, the third output 154 may include six channels, and the Nth output 158 may include six channels. More or less channels may be provided for each output based on the application.

In one example, a first gas is supplied to the first distributor 172 via the first inlet 182. The first gas may be, e.g., nitrogen (N₂). The N₂ gas is fed through the six channels 160 of the first output 150 to the foreline 112 before the pumps 130. A liquid is supplied to the second distributor 174 via the second inlet 184. The liquid may be, e.g., deionized water (DI-H₂O). The DI-H₂O is fed through the six channels 162 of the second output 152 to the foreline 112 after the plasma reactors 120. A second gas is supplied to the third distributor 176 via the third inlet 186. The second gas may be, e.g., oxygen (O₂). The O₂ gas is fed through the six channels 164 of the third output 154 to the foreline 112 before the plasma reactors 120. In some examples, other inlets may be connected to other distributors. For example, additional gas may be supplied to the Nth distributor 178 via the Nth inlet 188. The additional gas may be, e.g., argon (Ar). The gas is fed through the six channels (not shown) of the Nth output to any desired point of the foreline 112.

The system controller 110 is connected to an abatement controller 190 via ports 156. The ports 156 may be used to communicate signals between the system controller 110 and the abatement controller 190 via channel 166. The ports 156 may also be used for supplying voltage signals to the abatement controller 190. The abatement controller 190 may manage and optimize the abatement system's processes to minimize or neutralize harmful emissions and byproducts. The abatement controller 190 monitors emissions from the system, detects the presence of harmful gases, regulates the operation of the abatement system's components, such as heaters, burners, scrubbers, and reagent injection systems, and manages the flow of reagents.

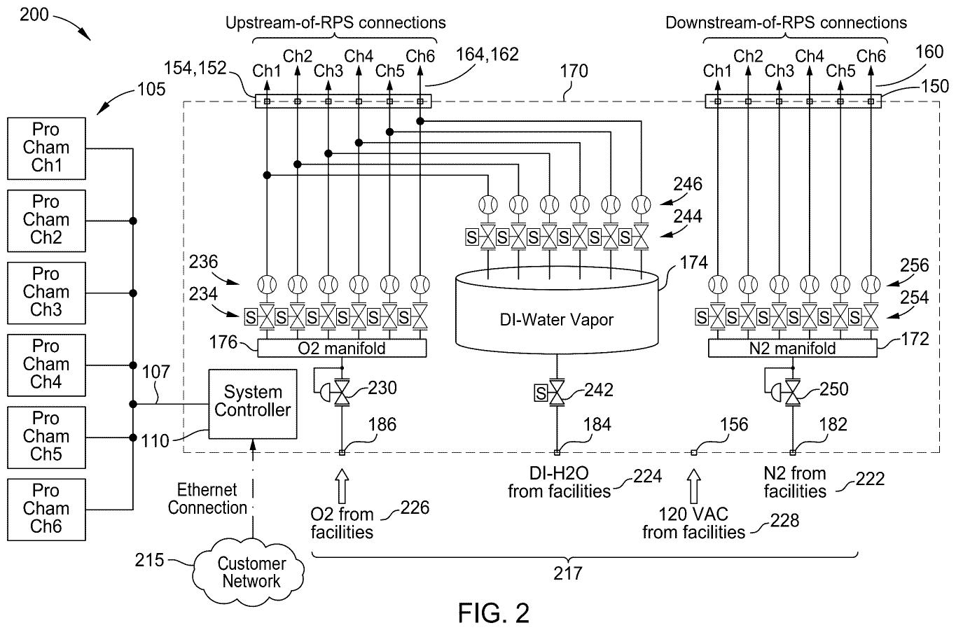

FIG. 2 is a schematic diagram of an abatement device enclosure of the processing system, according to one or more embodiments.

The system 200 includes the multiple chambers 105 coupled, via the connection 107, to the system controller 110 of the abatement system 170. A customer network 215 may also be coupled to the system controller 110.

According to an embodiment, one or more of the multiple chambers 105 may be a low temperature epitaxy (EPI) chamber, a plasma etch chamber, a CVD chamber, or other processing chamber, which generates effluent gases desirable for abatement. Each chamber is a controlled environment where chemical, thermal, and sometimes plasma processes are applied to the substrate.

In one example, etch chambers can be used for patterning the substrate by removing specific material layers. Etch chambers use plasma to achieve removal of material through chemical or physical reactions. In another example, deposition chambers can be used to add thin layers of material onto the substrate surface. Examples include CVD, Physical Vapor Deposition (PVD), and Atomic Layer Deposition (ALD) chambers. In another example, oxidation or diffusion chambers can be used, which operate at high temperatures, and operate in oxygen atmospheres to grow oxide layers on the substrate or diffuse dopants into the substrate. In another example, annealing chambers can be used to heat the substrate post-processing to repair crystal structure or activate dopants. In yet another example, rapid thermal processing (RTP) chambers may be used for processes that involve rapid heating or cooling of substrates. In yet another example, clean chambers can be used for cleaning substrates, using, e.g., wet chemicals, ultraviolet (UV)-ozone, or plasma treatments.

The multiple chambers 105 are coupled to the system controller 110. The system controller 110 may include at least a central processing unit (CPU), a memory containing instructions, and support circuits for the CPU. The system controller 110 controls various components directly, or via other computers and/or controllers. In one example, the system controller 110 may be incorporated within the abatement system 170. The system controller 110 can concurrently or simultaneously manage multiple processing chambers of a substrate processing tool. The system controller 110 may be referred to as a single system controller or a centralized system controller or a centralized controller.

In FIG. 2, six chambers are shown coupled to the system controller 110. More or less chambers may be coupled to the system controller 110. The system controller 110 optimizers resource usage and enhances coordination between the multiple chambers 105. The system controller 110 manages all of the multiple chambers 105, controlling each chamber's reagent delivery, pressure, temperature, and sequencing independently while coordinating across all chambers. The system controller 110 can be organized into channels, each dedicated to an individual chamber. This configuration enables parallel processing across the multiple chambers 105 while maintaining distinct conditions for each chamber. As such, the chambers can work in tandem (e.g., deposition in one chamber followed by annealing in another chamber), optimizing throughput. By managing each chamber, the system controller 110 reduces the need for duplicate sensors, controllers, and other hardware, thus streamlining the entire setup. Further, operators have a single point of access for monitoring, controlling, and adjusting parameters across each chamber. As such, process parameters can be updated in one place, applying changes across all chambers as needed.

The abatement device enclosure or the abatement system 170 receives multiple reagent gases. In one non-limiting example, the abatement device enclosure receives two reagent gases and a fluid. The abatement system 170 can receive more or less gases or fluids based on the application. In one example, the first reagent gas 222 is nitrogen (N₂), the first fluid 224 is deionized water (DI-H₂O), and the second reagent gas 226 is O₂. In other examples, other types of gases or fluids may be supplied. For example, reactive gases may include O₂ used post-abatement to oxidize residual byproducts, converting harmful gases into safer compounds or H₂ added for reactions with halogens like fluorine (F₂) to neutralize hazardous compounds. Inert or carrier gases may include N₂ used to transport other reactive species or to purge the system, preventing unwanted side reactions and argon (Ar) to provide a stable atmosphere and minimize contamination. Dilution gases may also be used to provide a stable environment for reactions or help transport reactive gases within the system without participating in the reaction. N₂ and helium (He) may be used for dilution to ensure reactions proceed safely and in a controlled manner. Cleaning or purging gases may also be used to help clear residues or contaminants between different process cycles, maintaining system integrity.

The abatement system 170 may also receive power 228 supplied by a power source (not shown). In one example, the power source may be, e.g., a 120 volts alternating current (VAC) power supply. Other suitable power sources may also be used based on application.

The first reagent gas 222 may be supplied to a nitrogen manifold (or the first distributor 172) via a valve 250. The nitrogen manifold regulates and distributes nitrogen from a central source to multiple outlets or channels. The nitrogen manifold delivers nitrogen for purging, inserting atmospheres, and pressure balancing. The nitrogen manifold includes a set of valves 254, where each valve is coupled to a respective flow meter 256. In one example, the set of valves 254 may be solenoid closed valves. Since six chambers are shown in this non-limiting example, the nitrogen manifold includes six valves and six flow meters. The gas flow from the six valves 254 is provided through six channels 160, e.g., upstream of remote plasm source (RPS) connections. Each valve 254 can regulate nitrogen flow independently, adjusting for specific requirements in each chamber 105. The number of valves and flow meters of the nitrogen manifold depend on the number of chambers used. Thus, each chamber can have a dedicated valve and flow meter to control nitrogen flow to each chamber, adjusting dynamically based on the number of active chambers. Each channel is associated with an outlet.

The first fluid 224 may be supplied to, e.g., a deionized (DI) water vapor chamber (or the second distributor 174) via a valve 242. The DI water vapor chamber can be used to control humidification, or chemical reactions that involve a specific moisture level. The DI water vapor chamber heats DI water to produce a consistent, controlled amount of vapor. The DI water vapor chamber includes a set of valves 244, where each valve is coupled to a respective flow meter 246. In one example, the set of valves 244 may be solenoid closed valves. Since six chambers are shown in this non-limiting example, the DI water vapor chamber includes six valves and six flow meters. The gas flow from the six valves 244 is provided through six channels 162, e.g., upstream of RPS connections.

In various embodiments, other chambers may be used instead of a DI water vapor chamber. Such chambers may be referred to as vaporization chambers or gas generator chambers. These chambers serve to vaporize or generate specific gases for delivery into the system. In one example, a nitrogen vaporization chamber may be used to generate nitrogen gas for processes that involve an inert atmosphere, purging, or for controlled nitrogen plasma reactions. In another example, an oxygen vaporization chamber may be used to produce oxygen gas, where reactive oxygen species are needed. In yet another example, a hydrogen or ammonia generator chamber may be used. As such, the DI water vapor chamber is presented as an illustrative example and may be replaced by any other type of vaporization chamber or gas generator chamber depending on the application.

Further, the DI water vapor chamber may need to be scaled up compared to conventional DI water vapor chambers because the DI water vapor chamber serves multiple chambers concurrently or simultaneously. A larger chamber can store and distribute a greater volume of DI water vapor, meeting the demand from multiple chambers. Serving multiple chambers from a single, larger DI water vapor chamber helps maintain uniform vapor quality and pressure, which is valuable for consistent processing across multiple chambers. Also, instead of maintaining separate vapor systems for each chamber, a single, larger vaporization chamber reduces the number of components and the associated complexity of monitoring and controlling them.

The second reagent gas 226 may be supplied to an oxygen manifold (or the third distributor 176) via a valve 230. The oxygen manifold delivers oxygen for reactions, usually for oxidation purposes or to neutralize hazardous byproducts. The oxygen manifold includes a set of valves 234, where each valve is coupled to a respective flow meter 236. In one example, the set of valves 234 may be solenoid closed valves. Since six chambers are shown in this non-limiting example, the oxygen manifold includes six valves and six flow meters. The gas flow from the six valves 234 is provided through six channels 164 upstream of, e.g., RPS connections. Each valve 234 can regulate oxygen flow independently, adjusting for specific requirements in each chamber 105. The number of valves and flow meters of the oxygen manifold depend on the number of chambers used. Thus, each chamber can have a dedicated valve and flow meter to control oxygen flow to each chamber, adjusting dynamically based on the number of active chambers. Each channel is associated with an outlet.

The gases and/or fluids may be supplied from a single point of connection 217. Having the single point of connection 217 for each reagent gas, fluid, and power delivery to support all chambers provides several efficiency and performance benefits. By centralizing connections, the system reduces the need for duplicate infrastructure, such as separate gas lines and power circuits for each chamber. This simplifies the setup, reduces material costs, and minimizes physical clutter. With each reagent gas, fluid, and power source managed through the single point of connection 217, it becomes easier to monitor and control supply levels and performance. Operators can adjust reagent flows or power output from one point, ensuring uniform conditions across the chambers. Centralized gas, fluid, and power distribution allows dynamic allocation based on each chamber's operational requirements. This setup enables efficient usage, as inactive or idle chambers do not consume gas or power, helping to reduce waste and operating costs. Each chamber receives identical gas composition and power levels from the single point of connection 217, ensuring that processes remain consistent across the chambers. With centralized connections, technicians can more easily identify and isolate issues related to reagent or power delivery. Maintenance can be performed more quickly, with minimal disruption to the entire tool's operation. The single point of connection 217 for each reagent gas and power source allows centralized emergency shut-offs, leak detection, and response systems. These features simplify compliance with safety standards and improve response times in emergency situations. Further, if new chambers are added, the centralized connection or the single point of connection 217 can be expanded to provide additional lines without reconfiguring multiple individual connections. This flexibility supports easy scalability as production requirements evolve.

The system controller 110 synchronizes gas flow operations across all the chambers 105, providing coordinated and automated regulation for each valve. In this setup, the system controller 110 can regulate gas flow based on each chamber's activity status. As such, the system controller 110 can dynamically manage gas distribution by controlling each chamber's corresponding valve. For idle chambers, the system controller 110 detects inactivity (based on process requirements, maintenance cycles, or real-time monitoring data). The system controller 110 then closes the valve supplying gas to that chamber. When a chamber becomes active (e.g., initiating a process or resuming operation), the system controller 110 reopens the corresponding valve, allowing gas to flow through the dedicated channel into the chamber. The valve opening is synchronized with process demands, ensuring gas flow when needed. Sensors within each chamber 105 provide continuous feedback to the system controller 110, which dynamically adjusts both the abatement processes and reagent flows to optimize conditions for each chamber 105.

The system controller 110 continuously monitors chamber status, using sensors to track pressure, temperature, and flow requirements. If these conditions change (e.g., an idle chamber needs to re-engage), the system controller 110 automatically adjusts the valve settings to match the new activity level. This setup enables on-demand, real-time adjustments to gas flow, optimizing resource usage and maintaining safe operational conditions. By regulating gas flow based on activity, the system controller 110 ensures that only active chambers receive the gases they need, reducing wastage and maintaining consistent processing conditions across chambers. The system controller 110 can handle simultaneous operations across multiple chambers 105, reducing resource waste by balancing reagent delivery and abatement activities according to each chamber's workload and current needs. This efficient control enhances the system's overall performance, ensuring gas delivery aligns with each chamber's operational status.

The centralized controller or system controller 110 simultaneously manages abatement processes to neutralize or capture byproducts generated during chamber operations. This dual functionality minimizes the release of harmful emissions and enables the safe disposal of process byproducts, which is beneficial for maintaining regulatory compliance and protecting both personnel and the environment. By integrating gas flow and abatement control, the system achieves a seamless balance of productivity, safety, and sustainability, enhancing the overall reliability and efficiency of the multi-chamber process tool.

In one non-limiting example, the first chamber, the second chamber, and the fourth chamber may be idle and the third chamber, the fifth chamber, and the sixth chamber may be active. The system controller 110 detects that the first chamber, the second chamber, and the fourth chamber are idle and closes the corresponding valves or reduces the flow to those chambers to conserve gases and avoid unnecessary emissions. The system controller 110 detects that the third chamber, the fifth chamber, and the sixth chamber are active and maintains or increases gas flow as needed by the chamber's specific processing needs. Each chamber's emission profile influences the gas flow rate and composition adjustment. If an active chamber has a higher emission rate or specific hazardous byproducts, the system controller 110 can increase the flow of neutralizing or reactive gases to manage the outputs effectively. This approach maximizes reagent efficiency and emission control, while ensuring that the chambers have appropriate flow needed for their specific purposes.

The abatement reagent delivery system 170 is housed in a single enclosure, including the system controller 110, the oxygen manifold (or the third distributor 176) with corresponding valves and flow meters, the nitrogen manifold with corresponding valves and flow meters, the DI water vapor chamber, and other support structures. The abatement device is thus integrated into a single, compact enclosure. The system controller 110 manages all functions, like valve operations, pressure regulation, and monitoring, from within the single enclosure. This integration may allow for seamless communication with each component, minimizing signal delays and simplifying wiring. The gas manifolds are installed within the single enclosure to distribute gases to various chambers through individual channels. Each manifold includes dedicated valves that regulate flow rates to ensure consistent delivery to each chamber.

Housing all components within a single enclosure reduces the overall footprint, making it easier to install and integrate into existing facilities. A single enclosure reduces the complexity of installation, wiring, and connections. Maintenance may also be simplified since technicians have centralized access to all components, decreasing downtime and lowering labor costs. Diagnostics and repairs are easier with all components housed in a single enclosure. With all components within a single enclosure providing for a controlled environment, potential gas leaks are better contained. The single enclosure can also include safety features, enhancing overall safety. Moreover, centralizing control and flow management in one single enclosure may reduce potential latency in communication between components, allowing for quicker and more accurate adjustments. Also, with fewer exposed connection points, there is a reduced chance of contamination from external sources.

Combining plasma abatement controller and reagent gas delivery functions into a single integrated device offers several benefits, including at least reduced complexity, cost reduction, faster and easier installation, space savings in sub-fabs, enhanced scalability, and improved reliability and performance. The gas flow control functions may include flow rate regulation, dynamic adjustments, selective gas injection, pressure management, and purge functions. The abatement control functions may include plasma generation control, emission monitoring, temperature control, feedback control, and diagnostics and alerts.

By integrating the abatement control and reagent gas delivery into a single system or device, the need for separate controllers and gas lines for each chamber is eliminated. This reduces the number of components, such as flow meters, control valves, and pipelines, used to manage emissions and reagent gases. A single controller or centralized controller manages the abatement and reagent delivery functions across all chambers, simplifying the system's operation and reducing the complexity involved in coordinating multiple independent systems.

Consolidating these functions reduces the need for duplicate hardware, such as multiple controllers, gas lines, and monitoring systems for each chamber. This leads to significant savings in the overall equipment costs. The integrated system can dynamically adjust the reagent gas flow across chambers, ensuring optimal gas usage and minimizing waste. This lowers operational costs related to reagent consumption. With fewer components to maintain, the overall cost of system upkeep decreases. The simplified architecture also allows for easier troubleshooting and fewer points of failure.

The integrated system reduces the number of connections, gas lines, and controllers that need to be installed and calibrated, leading to a faster setup process. This minimizes installation time and allows fabs to start operations more quickly. Since the system or device is constructed as a single unit, it can be more easily integrated into existing fab setups, reducing the technical complexity and labor involved during installation.

By consolidating the abatement and reagent delivery systems into one system or device, the overall space needed for the system is significantly reduced. This is beneficial in, e.g., the sub-fab, where space is limited and often costly. With fewer components and pipelines occupying space, the integrated system allows fabs to use the available area more efficiently, freeing up room for other essential equipment or expanding the production capabilities within the same footprint. The unified system is well-suited for larger, multi-chamber tools, making it easier to scale up operations as more process chambers are added. Instead of installing additional controllers and gas lines, the centralized system can handle increased capacity with minimal adjustments.

Combining the systems into one integrated device reduces the number of individual components, lowering the likelihood of failure. This enhances the overall reliability of the process tool and minimizes downtime. With a single device managing both functions, the system can offer better real-time monitoring and control, enabling more precise and responsive adjustments to process conditions across multiple chambers.

Combining the plasma abatement controller and reagent gas delivery functions into a single integrated system, with advanced connectivity to the customer network 215, offers additional benefits through enhanced remote access, control, and data management. Such advantages may include at least remote login and control, centralized monitoring and data collection, integration with other sub-fab support equipment, enhanced troubleshooting and diagnostics, data-driven process optimization, increased safety and compliance, reduced downtime, and faster maintenance.

With the integrated system connected to the customer network 215, remote login capabilities allow operators to access, control, and monitor the system from virtually anywhere. This improves operational flexibility, as technicians and engineers can manage abatement and reagent delivery functions without needing to be on-site. Remote access enables immediate adjustments to the system settings in response to changing process conditions, improving reaction times to potential problems. This can lead to minimized downtime and better system uptime.

The ability to monitor the combined plasma abatement and reagent delivery system from a central location allows for real-time data collection and performance tracking. This centralized data collection provides a holistic view of the system's operation, identifying inefficiencies or irregularities in abatement and reagent use across multiple chambers. Real-time data collection enables predictive analytics for maintenance, reducing the likelihood of unplanned system outages. With continuous monitoring, wear and performance degradation of components can be detected early, allowing for scheduled maintenance before any critical failure occurs.

By connecting the abatement and gas delivery system to the customer network 215, the system can also integrate with other sub-fab support equipment, such as vacuum pumps, chillers, and scrubbers. This allows for the collection and monitoring of data from multiple systems in a unified platform, giving a broader and more accurate picture of sub-fab operations. Integrating the data from various systems enhances the ability to optimize the entire sub-fab environment. For instance, correlations between the performance of abatement systems, vacuum pumps, and temperature control units can be identified, enabling better optimization of resource use and process efficiency.

By connecting the abatement and gas delivery system to the customer network 215, the system can provide real-time performance monitoring, enhanced predictive maintenance, improved process control, energy efficiency, and centralized data management capabilities to the users or operators of the customer network 215. The system controller 110 gathers data from all equipment within the single device, allowing real-time monitoring and enabling quick detection of deviations from expected parameters. The system controller 110 can provide predictive maintenance scheduling based on real-time data to help prevent unexpected downtimes, extend equipment lifespan, and reduce repair costs. Integrated monitoring can support tighter process control, as each piece of equipment can be adjusted dynamically based on the data from other systems. The customer network 215 can be used to coordinate equipment to optimize energy usage. For example, an operator of the customer network 215 can adjust heaters, chillers, and pumps in tandem, potentially leading to energy savings by preventing overuse or unnecessary cycling. All the data can be collected from a single access point (i.e., the system controller 110), which may simplify analysis and reporting.

The system's connectivity further allows for detailed diagnostics to be performed remotely, enabling quick identification of issues without using on-site personnel. Remote troubleshooting shortens the time to resolution for problems and reduces the need for costly site visits by engineers or service personnel. The integrated system can generate automated alerts for any performance deviations, equipment malfunctions, or abnormal reagent usage, enabling immediate action. This reduces the risk of small issues escalating into major failures.

With continuous data collection and the ability to analyze historical performance, users can refine abatement processes and reagent delivery to optimize efficiency and resource utilization. The system's data can be used to improve decision-making on gas flow rates, abatement timing, and reagent usage based on actual performance data. Data-driven insights allow for fine-tuning of operations, leading to more efficient use of reagent gases and energy. Over time, this results in cost savings and a more sustainable fab environment.

The system's ability to monitor hazardous emissions and gas usage remotely ensures that safety protocols are being followed, and any deviations from safe operating conditions can be immediately addressed. This helps ensure compliance with environmental and safety regulations while minimizing risk. With centralized data collection, the system can automatically generate reports on emissions, reagent usage, and abatement efficiency, simplifying compliance reporting for environmental regulations.

By connecting to the customer network 215 and allowing for real-time data collection, the system can monitor the health of critical sub-fab components such as pumps, gas lines, and abatement chambers. Early detection of any issues reduces the chances of unexpected system failures, leading to reduced downtime. With all equipment data centrally available, maintenance activities can be coordinated and scheduled more efficiently, ensuring that maintenance only occurs when necessary and without disrupting operations. As fabs expand or upgrade, the integrated system's network connectivity makes it easy to add new chambers or tools and scale the abatement and reagent delivery functions. By enabling network connectivity, the system can be easily integrated into broader Industry 4.0 or Internet-of-Things (IoT) frameworks. This allows the fab to leverage advanced analytics, artificial intelligence (AI)-driven process optimizations, and predictive maintenance tools in the future.

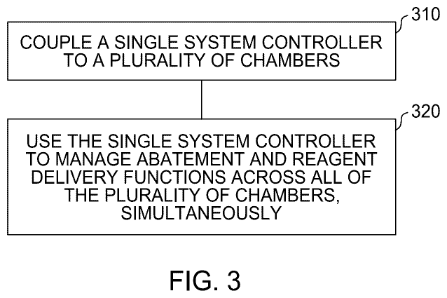

FIG. 3 is a flowchart illustrating using a system controller to manage abatement and reagent delivery functions, according to one or more embodiments.

At operation 310, a single control system is coupled to multiple chambers. The central controller synchronizes gas flow operations across all chambers, providing coordinated and automated regulation for each valve. The single system controller can adjust flow rates, timing, and sequences based on the specific requirements of each chamber's process. The single system controller also monitors real-time data from each chamber to dynamically adjust each valve's output.

At operation 320, the single control system is used to manage abatement and reagent delivery functions across all of the multiple chambers simultaneously. The single system controller regulates reagent delivery to each chamber based on its specific requirements while simultaneously managing abatement processes to neutralize or capture byproducts. This setup allows for dynamic adjustments in real-time, reducing any delays between reagent injection and byproduct treatment.

In conclusion, the example embodiments allow for the plasma abatement controller and reagent gas delivery functions for a substrate processing tool to be combined into a single integrated device. This unified system centralizes control over the abatement system and its gas delivery operations across multiple chambers within the process tool, facilitating streamlined management of reagent gas supply and plasma abatement for all chambers simultaneously. Instead of having separate controllers and delivery components for each chamber, this architecture integrates these functions into one device that handles the abatement needs of the entire tool, regardless of the specific processes running in each chamber.

The centralized controller's role in dynamically adjusting reagent gas flow across multiple chambers offers significant efficiency and control. By continuously monitoring each chamber's activity status, whether idle or active, the centralized controller directs gas flow only where needed, conserving resources and optimizing operational costs. This real-time adaptability ensures that active chambers receive adequate reagent supply for consistent processing, while idle chambers do not consume unnecessary resources. The centralized control streamlines operations, reducing redundancy and enhancing response times when adjustments in gas flow are needed.

In addition to regulating gas flow, the centralized controller simultaneously manages abatement processes to neutralize or capture byproducts generated during chamber operations. This dual functionality minimizes the release of harmful emissions and enables the safe disposal of process byproducts, which is beneficial for maintaining regulatory compliance and protecting both personnel and the environment. By integrating gas flow and abatement control, the system achieves a seamless balance of productivity, safety, and sustainability, enhancing the overall reliability and efficiency of the multi-chamber process tool.

When introducing elements of the present disclosure or exemplary aspects or embodiments thereof, the articles “a,” “an,” “the” and “said” are intended to mean that there are one or more of the elements.

The terms “comprising,” “including” and “having” are intended to be inclusive and mean that there may be additional elements other than the listed elements.

The term “coupled” is used herein to refer to the direct or indirect coupling between two objects. For example, if object A physically touches object B and object B touches object C, the objects A and C may still be considered coupled to one another-even if objects A and C do not directly physically touch each other. For instance, a first object may be coupled to a second object even though the first object is never directly in physical contact with the second object.

While the foregoing is directed to embodiments of the present disclosure, other and further embodiments of the disclosure may be devised without departing from the basic scope thereof, and the scope thereof is determined by the claims that follow.

What is claimed is:

1. An abatement device, comprising:
a foreline plasma reactor;
a reagent delivery system configured to provide one or more reagent gases to a foreline coupled upstream of the foreline plasma reactor; and
a system controller incorporated within the reagent delivery system and configured to simultaneously control reagent delivery and abatement functions of multiple chambers of a substrate processing tool.

2. The abatement device of claim 1, wherein the reagent delivery system further comprises a first reagent inlet port coupled to multiple first reagent outlet ports via a first distributor.

3. The abatement device of claim 2, wherein the reagent delivery system further comprises a second reagent inlet port coupled to multiple second reagent outlet ports via a second distributor, the second distributor including a vaporization chamber.

4. The abatement device of claim 1, wherein the system controller is configured to dynamically adjust a flow of the one or more reagent gases based on emission profiles of the multiple chambers.

5. The abatement device of claim 1, wherein the system controller is configured to regulate reagent gas delivery to each of the multiple chambers while simultaneously managing abatement processes to neutralize or capture byproducts.

6. The abatement device of claim 1, wherein the system controller is coupled to a network.

7. The abatement device of claim 6, wherein the network is configured to enable at least remote login and control, centralized monitoring and data collection, integration with sub-fab support equipment, troubleshooting and diagnostics capabilities, and data-driven process optimization.

8. A reagent delivery system, comprising:
a plurality of reagent distributors, each distributor configured to controllably split distribution of a reagent provided to the reagent delivery system among a plurality of reagent distributor outlet ports; and
a system controller configured to simultaneously flow from the plurality of reagent distributor outlet ports to multiple chambers of a substrate processing tool.

9. The reagent delivery system of claim 8, wherein the system controller is further configured to control functions of foreline plasma reactors coupled to outlets of the multiple chambers.

10. The reagent delivery system of claim 8, wherein a first distributor of the plurality of reagent distributors is coupled a first reagent inlet port.

11. The reagent delivery system of claim 10, wherein the first reagent inlet port is coupled through the first distributor to a first group reagent distributor outlet ports of the plurality of reagent distributor outlet ports; and
wherein a second reagent inlet port is coupled through the first distributor of the plurality of reagent distributors to a second group reagent distributor outlet ports of the plurality of reagent distributor outlet ports.

12. The reagent delivery system of claim 8, wherein the system controller is configured to dynamically adjust a flow of reagent gases based on emission profiles of the multiple chambers.

13. The reagent delivery system of claim 8, wherein the system controller is coupled to a network.

14. The reagent delivery system of claim 13, wherein the network is configured to enable at least remote login and control, centralized monitoring and data collection, integration with sub-fab support equipment, troubleshooting and diagnostics capabilities, and data-driven process optimization.

15. A method, comprising:
controlling, using a system controller, reagent gas delivery to a first foreline coupled to a first processing chamber a substrate processing tool; and
simultaneously controlling, using the system controller, a reagent gas delivery to a second foreline coupled to a second processing chamber of the substrate processing tool.

16. The method of claim 15 further comprising:
controlling, using the system controller, a first foreline plasma reactor coupled to the first foreline; and
simultaneously controlling, using the system controller, a second foreline plasma reactor coupled to the second foreline.

17. The method of claim 16, wherein controlling the first foreline plasma reactor is based on chamber status received by the system controller.

18. The method of claim 15, wherein controlling the reagent gas delivery to the first foreline is based on chamber status received by the system controller.

19. The method of claim 15 further comprising:
controlling, using the system controller, the reagent gas delivery to forelines of all other processing chambers of the substrate processing tool.

20. The method of claim 15, wherein the system controller is coupled to a network.
